(19) United States
(12) Patent Application Publication
(10) Pub. No.: US 2025/0141650 A1
(43) Pub. Date: May 1, 2025

(54) SYSTEM AND METHOD FOR REDUCING SELF-INTERFERENCE IN FULL-DUPLEX SYSTEM

(71) Applicant: Keysight Technologies, Inc., Santa Rosa, CA (US)

(72) Inventors: Michael Millhaem, Santa Rosa, CA (US); Abhinav Mahadevan, Santa Rosa, CA (US); Taekyun Lee, Santa Rosa, CA (US)

(21) Appl. No.: 18/815,389

(22) Filed: Aug. 26, 2024

Related U.S. Application Data
(60) Provisional application No. 63/546,306, filed on Oct. 30, 2023.

(51) Int. Cl. H04L 5/14; H04L 25/02

(52) U.S. Cl. CPC H04L 5/14; H04L 25/0224

(57) ABSTRACT

A method calibrates a full-duplex system including co-located transmitter and receiver. The method includes transmitting a test RF signal from the transmitter, the test RF signal including a predetermined channel sounding waveform at a carrier frequency; receiving RF signals at the receiver, including an outside RF signal at the carrier frequency received from an external transmitter and self-interference at the carrier frequency including a first portion of the test RF signal received directly from the transmitter; identifying the predetermined channel sounding waveform; quantifying the self-interference using the identified channel sounding waveform by determining a first interference signal of the received RF signals attributable to the first portion of the test RF signal received directly from the transmitter based on the identified channel sounding waveform and first timing associated with a first distance between the receiver and the transmitter; and adjusting the full-duplex system to correct for the quantified self-interference.

### CROSS-REFERENCE TO RELATED APPLICATIONS

A claim of priority is made under 35 U.S.C. § 119(e) to U.S. Provisional Application 63/546,306, filed on Oct. 30, 2023. The entire disclosure of U.S. Provisional Application 63/546,306 is specifically incorporated herein by reference in its entirety.

### BACKGROUND

A full-duplex system includes a transmitter and receiver at substantially the same location, which transmits and receives simultaneously on the same frequency. A full-duplex system may provide significantly improved spectrum efficiency for radio frequency (RF) communications, including 5G communications, for example. However, such systems suffer from self-interference because portions of the RF signals transmitted by the transmitter are received by the receiver, both directly and by reflection from near objects in the immediate vicinity. The self-interference is especially problematic since the RF signals are typically transmitted by the transmitter 60-80 dB higher than the level of the desired signals expected to be received by the receiver, so the direct or reflected path may be significantly larger than desired signal.

To improve designs of full-duplex system or to otherwise provide efficient operation, precise and time-consuming calibration would have to be performed on the full-duplex systems to cancel the self-interference. However, any such calibrations would be mostly manual and involve making large codebook changes, which are not controlled properly.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1A is a simplified block diagram of a system for reducing self-interference in a full-duplex system including collocated transmitter and receiver with corresponding antennas, according to a representative embodiment.

FIG. 1B is a simplified block diagram of a test system for reducing self-interference in a full-duplex system including collocated transmitter and receiver with a common, according to a representative embodiment.

FIG. 2 is a flow diagram illustrating a method of reducing self-interference in a full-duplex system including a transmitter and a receiver co-located with the transmitter, according to a representative embodiment.

FIG. 3 is a simplified block diagram of a representative controller, according to a representative embodiment.

### DETAILED DESCRIPTION

In the following detailed description, for purposes of explanation and not limitation, representative embodiments disclosing specific details are set forth in order to provide a thorough understanding of an embodiment according to the present teachings. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. The defined terms are in addition to the technical and scientific meanings of the defined terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure.

The terminology used herein is for purposes of describing particular embodiments only and is not intended to be limiting. As used in the specification and appended claims, the singular forms of terms “a,” “an” and “the” are intended to include both singular and plural forms, unless the context clearly dictates otherwise. Additionally, the terms “comprises,” and/or “comprising,” and/or similar terms when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

Unless otherwise noted, when an element or component is said to be “connected to,” “coupled to,” or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

The present disclosure, through one or more of its various aspects, embodiments and/or specific features or sub-components, is thus intended to bring out one or more of the advantages as specifically noted below. For purposes of explanation and not limitation, example embodiments disclosing specific details are set forth in order to provide a thorough understanding of an embodiment according to the present teachings. However, other embodiments consistent with the present disclosure that depart from specific details disclosed herein remain within the scope of the appended claims. Moreover, descriptions of well-known apparatuses and methods may be omitted so as to not obscure the description of the example embodiments. Such methods and apparatuses are within the scope of the present disclosure.

According to a representative embodiment, a method is provided for reducing self-interference in a full-duplex system including a transmitter and a receiver co-located with the transmitter. The method includes transmitting a test radio frequency (RF) signal from the transmitter of the full-duplex system, where the test RF signal includes a predetermined channel sounding waveform at a carrier frequency; receiving RF signals at the receiver of the full-duplex system, substantially simultaneously with the transmitting of the test RF signal, where the received RF signals include a outside RF signal at the carrier frequency received from an external transmitter and self-interference at the carrier frequency including a first portion of the test RF signal received directly from the transmitter; identifying the predetermined channel sounding waveform in the received RF signals; quantifying the self-interference using the identified channel sounding waveform, where quantifying the self-interference includes determining a first interference signal of the received RF signals attributable to the first portion of the test RF signal received directly from the transmitter based on the identified channel sounding waveform and first timing of the identified channel sounding waveform associated with a first distance between the receiver and the transmitter, and determining a second interference signal of the received RF signals attributable to a second portion of the test RF signal reflected to the receiver from at least one near object and second timing of the identified channel sounding waveform associated with a second distance between the receiver and the at least one near object; and adjusting the full-duplex system to correct for the quantified self-interference.

According to another representative embodiment, a system is provided for reducing self-interference in a full-duplex system including a transmitter and a receiver co-located with the transmitter. The system includes at least one external transmitter configured to transmit a outside RF signal at a carrier frequency, optionally at least one near object positioned a predetermined second distance from the receiver, and a processing unit configured to communicate with the co-located transmitter and receiver. The transmitter is configured to transmit a test RF signal including a predetermined channel sounding waveform at the carrier frequency, the receiver is configured to receive RF signals substantially simultaneously with the transmitter transmitting the test RF signal, the received RF signals including the outside RF signal received from the external transmitter and self-interference, including a first portion of the test RF signal received directly from the transmitter and a second portion of the test RF signal reflected to the receiver from the at least one near object. The processing unit is configured to identify the predetermined channel sounding waveform in the received RF signals; and quantify the self-interference using the identified channel sounding waveform, where quantifying the self-interference includes determining a first interference signal of the received RF signals attributable to the first portion of the test RF signal received directly from the transmitter based on the identified channel sounding waveform and first timing of the identified channel sounding waveform associated with a first distance between the receiver and the transmitter, and determining a second interference signal of the received RF signals attributable to the second portion of the test RF signal reflected to the receiver from the at least one near object and second timing of the identified channel sounding waveform associated with the second distance between the receiver and the at least one near object, where the second timing is longer than the first timing; and adjust the full-duplex system to correct for the quantified self-interference.

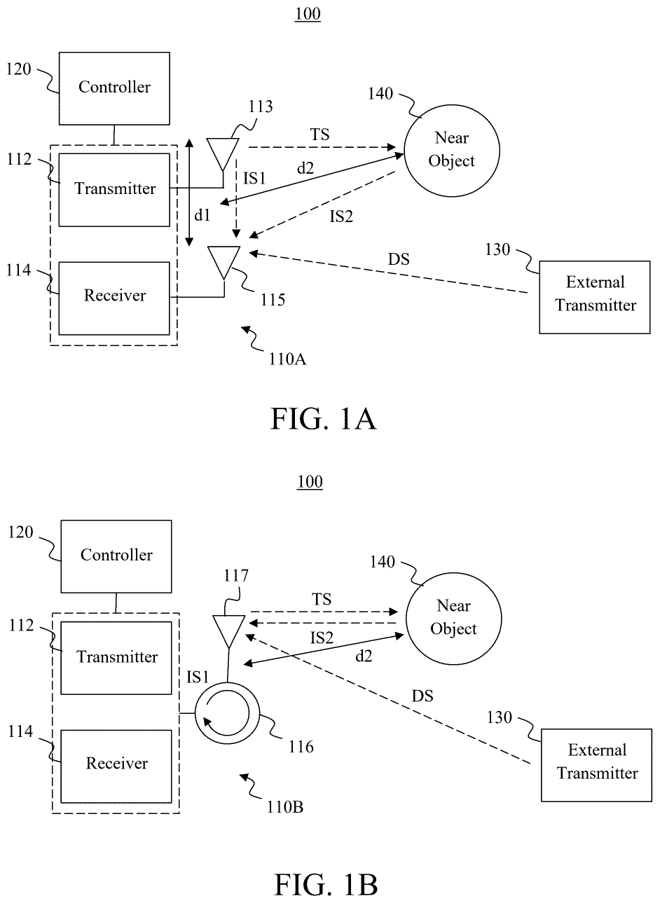

FIG. 1A is a simplified block diagram of a test system for reducing self-interference in a full-duplex system including collocated transmitter and receiver with corresponding antennas, according to a representative embodiment. FIG. 1B is a simplified block diagram of a test system for reducing self-interference in a full-duplex system including collocated transmitter and receiver with a common, according to a representative embodiment. The test systems in FIGS. 1A and 1B may be used for design validation testing during design and development of full-duplex systems, for example, enabling design changes to reduce self-interference identified during the testing. Alternatively, or in addition, the test systems in FIGS. 1A and 1B may be used for calibrating full-duplex systems in order to reduce self-interference during operation of these systems.

Referring to FIG. 1A, a test system 100 is configured to test and/or calibrate a full-duplex system 110A, which includes transmitter 112, transmit (TX) antenna 113, receiver 114 and (RX) antenna 115. The receiver 114 is collocated with the transmitter 112, meaning that the transmitter 112 and receiver 114 are at substantially the same physical location.

The test system 100 includes a controller 120, configured to communicate with the transmitter 112 and the receiver 114, and one or more external transmitters indicated by representative external transmitter 130, in order to make channel sounding measurements. Under control of the controller 120, the transmitter 112 transmits a test RF signal (TS), which includes a predetermined channel sounding waveform at a predetermined carrier frequency. Meanwhile, the external transmitter 130 transmits a desired outside RF signal at the same carrier frequency. The external transmitter 130 may be configured to transmit additional outside RF signals (OS) at different carrier frequencies, and/or the test system 100 may include additional external transmitters that transmit additional outside RF signals, respectively, at different carrier frequencies. In this case, the transmitter 112 is controlled to transmit additional test RF signals including predetermined channel sounding waveforms at the different carrier frequencies in order to broaden the scope of the testing.

The predetermined channel sounding waveform is a known waveform pattern that modulates the test RF signal at the predetermined carrier frequency. The waveform pattern is distinguishable over random noise and over other waveform patterns that may be used to communicate with the full-duplex system 110A (or full-duplex system 110B, discussed below). The waveform pattern also has distinctive attributes that may be associated with transmission times from the transmitter 112 to enable determination of the timing of different portions or copies of the test RF signal being received at the receiver 114, as discussed below. The predetermined channel sounding waveform PathWave Vector Signal Analysis (89600 VSA) Software

In various embodiments, the test system 100 may further include one or more optional near objects, indicated by representative near object 140. The near object 140 is closer to the TX antenna 113 and the RX antenna 115 than the external transmitter 130, and is configured to reflect the test RF signal transmitted by the transmitter 112. The near object 140 may be formed of a reflective material, such as aluminum, for example.

The receiver 114 is configured to receive RF signals substantially simultaneously with the transmitter 112 transmitting the test RF signal. The received RF signals include the outside RF signal received from the external transmitter 130 and self-interference received from the transmitter 112 at the carrier frequency. Since the transmitter 112 transmits the test RF signal in a multipath environment, the self-interference includes a first portion of the test RF signal, which is received by the receiver 114 directly from the transmitter 112 (line-of-sight), as well as a second portion of the test RF signal, which is received by the receiver 114 after being reflected from the near object 140. Generally, the first portion of the test RF signal leaks from the TX antenna 113 directly to the RX antenna 115.

The controller 120 is able to identify the predetermined channel sounding waveform enabling characterization of the multipath environment with regard to the test RF signal. The controller 120 quantifies the self-interference using the identified channel sounding waveform and the timing information. The channel sounding waveform and the timing information may be identified using 89600 vector signal analysis (VSA) software, for example, available from Keysight Technologies, Inc.

Quantifying the self-interference includes determining a first interference signal (IS1) of the received RF signals attributable to the first portion of the test RF signal received directly from the transmitter 120 based on the identified channel sounding waveform and first timing of the identified channel sounding waveform. The first timing is associated with a first distance d1 between the TX antenna 112 and the RX antenna 115. That is, the first timing is the known time between the same portion of the identified channel sounding waveform being transmitted by the transmitter 112 and received by the receiver 114 after traveling the first distance d1. The first timing is determined as the speed of light traveling the first distance d1. The controller 120 is able to distinguish the first interference signal from the outside RF signal received from the external transmitter 130 because the outside RF signal does not include the predetermined channel sounding waveform.

When the test system 100 includes the near object 140, quantifying the self-interference further includes determining a second interference signal (IS2) of the received RF signals attributable to the second portion of the test RF signal reflected to the receiver 114 from the near object 140 based on the identified channel sounding waveform and second timing of the identified channel sounding waveform. The second timing is associated with a second distance d2 between the transceiver 110 and the near object 140. Since the second distance d2 is longer than the first distance d1, it follows that the second timing is longer than the first timing. In this case, the second timing is the known time between a portion of the identified channel sounding waveform being transmitted by the transmitter 112, traveling the second distance d2, being reflected by the near object 140, traveling the second distance d2, and then being received by the receiver 114. Since the transmitter 112 and the receiver 114 are co-located, the total distance traveled is about 2·d2. The controller 120 is able to distinguish the second interference signal from the first interference signal because of the second timing of the same portion of the identified channel sounding waveform being longer than the first timing. Also, the controller 120 is able to distinguish the second interference signal from the outside RF signal received from the external transmitter 130 because the outside RF signal does not include the predetermined channel sounding waveform, as mentioned above.

Referring to FIG. 1B, the test system 100 is configured to test and/or calibrate a full-duplex system 110B, which includes transmitter 112, receiver 114, circulator 116 and common antenna 117. Again, the receiver 114 is co-located with the transmitter 112, meaning that the transmitter 112 and receiver 114 are at substantially the same physical location. The circulator 116 is configured to selectively route the RF signals from the transmitter 112, including the test RF signal, to the antenna 117 and to route received RF signals from the antenna 117 to the receiver 114. The first portion of the test RF signal received by the receiver 114 directly from the transmitter 112 leaks through the circulator 116.

In both configurations, once the controller 120 has quantified the self-interference, adjustments may be made to the full-duplex system 110A or 110B to correct for the quantified self-interference. As mentioned above, the adjustments may be made during design and development of the full-duplex system 110A or 110B so that the finished product experiences little to no self-interference. Alternatively, when the full-duplex system 110A or 110B is operational, the adjustments may be made during calibration in order to reduce the self-interference during operations.

In an embodiment, the controller 120 may adjust the full-duplex system 110A or 110B to correct for the quantified self-interference by determining an impulse response of the quantified self-interference. By correcting for the quantified self-interference, isolation between the transmitter 112 and the receiver 114 may be increased significantly, e.g., by about 30 dB. The impulse response can be determined Then, the controller 120 inserts a digital impulse response filter in the full-duplex system 110A or 110B to filter out the quantified self-interference at the receiver 120. When the quantified self-interference includes first and second interference signals, the controller 120 may determine an impulse response for each of the first and second interference signals, and apply two corresponding impulse response filters. Or, the controller 120 may determine the combined impulse response and applying one corresponding impulse response filter.

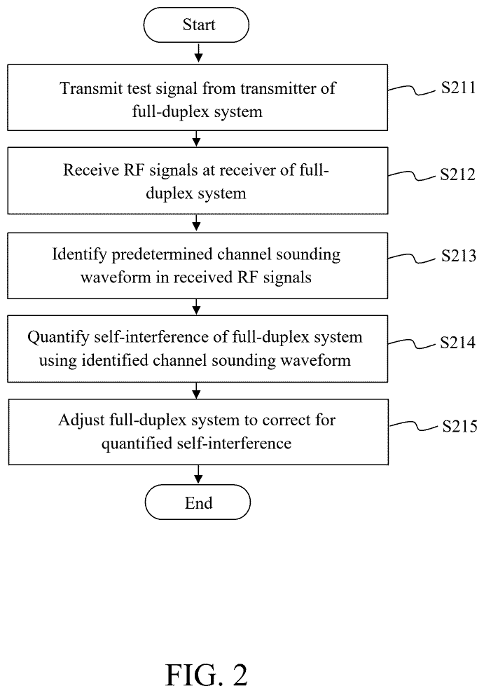

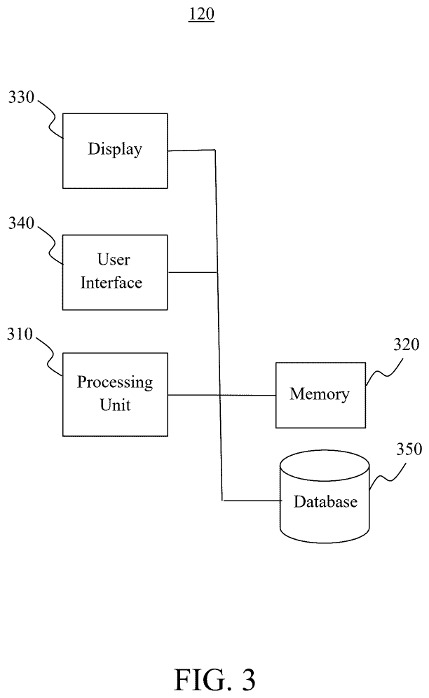

FIG. 2 is a flow diagram illustrating a method of reducing self-interference in a full-duplex system including a transmitter and a receiver co-located with the transmitter, according to a representative embodiment. The method may be implemented at least in part by the controller 120, for example, discussed above with reference to FIG. 1, where the method steps are provided as instructions stored in the memory 320 and executable by the processing unit 310, for example, discussed below with reference to FIG. 3.

Referring to FIG. 2, a test RF signal is transmitted from the transmitter of the full-duplex system in block S211. The test RF signal includes a predetermined channel sounding waveform at a predetermined carrier frequency.

In block S212, RF signals are received at the receiver of the full-duplex system, substantially simultaneously with the transmitting of the test RF signal. The received RF signals include self-interference at the carrier frequency, as well as an outside RF signal at the same carrier frequency received from an external transmitter. The self-interference includes at least a first portion of the test RF signal that is received (leaked) directly from the transmitter. When a near object is present during the testing, the self-interference further includes a second portion of the test RF signal that is received (reflected) from the near object. Likewise, one or more additional near objects being present results in the self-interference further including corresponding one or more additional portions of the test RF signal reflected by the one or more additional near objects, respectively.

In block S213, the predetermined channel sounding waveform is identified in the received RF signals. The predetermined channel sounding waveform may be identified based on a distinctive waveform pattern. The identified channel sounding waveform distinguishes RF signals received from the transmitter, either directly or reflected from the near object, from one or more other RF signals received by the receiver, including the outside RF signal transmitted by the external transmitter.

In block S214, the self-interference of the full-duplex system is quantified using the identified channel sounding waveform. Quantifying the self-interference includes at least determining a first interference signal of the received RF signals attributable to the first portion of the test RF signal received directly from the transmitter. The first interference signal may be determined based on the identified channel sounding waveform and first timing of the identified channel sounding waveform associated with a first distance between the receiver and the transmitter. That is, the first timing is the time between transmission of the channel sounding waveform by the transmitter and reception of the first interference signal by the receiver.

When a near object is present, quantifying the self-interference further includes determining a second interference signal of the received RF signals attributable to a second portion of the test RF signal, which is the portion of the test RF signal that is reflected to the receiver from the near object. The second interference signal may be determined based on the identified channel sounding waveform and second timing of the identified channel sounding waveform associated with a second distance between the receiver and the near object. That is, the second timing is the time from transmission of the channel sounding waveform by the transmitter, reflection of the second interference signal portion of the channel sounding waveform by the near object, and reception of the second interference signal by the receiver. Due to the longer distance from the transmitter to the near object back to the received, as compared to the direct distance between the co-located transmitter and receiver, the second timing is longer than the first timing.

In block S215, the full-duplex system is adjusted to correct for the quantified self-interference. In an embodiment, adjusting the full-duplex system to correct for the quantified self-interference may include determining an impulse response of the quantified self-interference. Then, an impulse response filter for filtering out the impulse response is inserted in the full-duplex system, thereby removing the quantified self-interference at the receiver.

In another embodiment, when a TX antenna of the transmitter and an RX antenna of the receiver are array antennas, adjusting the full-duplex system to correct for the quantified self-interference may include changing at least one of the TX array antenna or the RX array antenna to reduce at least the first interference signal of the quantified self-interference attributable to the first portion of the test RF signal received directly from the transmitter. For example, changing the TX array antenna or the RX array antenna may include adjusting power and/or phase of antenna array elements within the TX array antenna or the RX array antenna.

FIG. 3 is a simplified block diagram of a representative controller, such as the controller 120 in FIG. 1, according to a representative embodiment. All or part of the controller 120 may be included in an oscilloscope, a digital communication analyzer (DCA), or other RF test equipment, for example, without departing from the scope of the present teachings.

Referring to FIG. 3, the controller 120 includes a processing unit 310, memory 320 for storing instructions executable by the processing unit 310 to implement the processes described herein, as well as a display 330 and an interface 340 to enable user interaction. The processing unit 310 may access a database 350 that stores information to be used for testing and/or calibrating a full-duplex system, such as procedures and specifications of the full-duplex system, for example. The term “controller” broadly encompasses all structural configurations, as understood in the art of the present disclosure and as exemplarily described in the present disclosure, of an application specific main board or an application specific integrated circuit for controlling application of various principles as described in the present disclosure. The structural configuration of the controller 120 may include, but is not limited to, processor(s), computer-usable/computer readable storage medium(s), an operating system, application module(s), peripheral device controller(s), slot(s) and port(s), as discussed below.

The processing unit 310 is representative of one or more processing devices, and is configured to execute software instructions to perform functions as described in the various embodiments herein. The processing unit 310 may be implemented by a general purpose computer, a central processing unit, one or more processors, microprocessors or microcontrollers, a state machine, a programmable logic device, field programmable gate arrays (FPGAs), application specific integrated circuits (ASICs), or combinations thereof, using any combination of hardware, software, firmware, hard-wired logic circuits, or combinations thereof. The term “processor,” in particular, encompasses an electronic component able to execute a program or machine executable instructions. References to a processor should be interpreted to include more than one processor or processing core, as in a multi-core processor, and/or parallel processors. Programs have software instructions performed by one or multiple processors that may be within the same computing device or which may be distributed across multiple computing devices.

The memory 320 may include a main memory and/or a static memory, where such memories may communicate with each other and the processing unit 310 via one or more buses. The memory 320 stores instructions used to implement some or all aspects of methods and processes described herein, including the methods described above with reference to FIG. 2, for example. The memory 320 may be implemented by any number, type and combination of random access memory (RAM) and read-only memory (ROM), for example, and may store various types of information, such as software algorithms, data based models including neural network based models, and computer programs, all of which are executable by the processing unit 310. The various types of ROM and RAM may include any number, type and combination of computer readable storage media, such as a disk drive, flash memory, an electrically programmable read-only memory (EPROM), an electrically erasable and programmable read only memory (EEPROM), registers, a hard disk, a removable disk, tape, compact disk read only memory (CD-ROM), digital versatile disk (DVD), floppy disk, blu-ray disk, a universal serial bus (USB) drive, or any other form of storage medium known in the art.

The memory 320 is a tangible storage medium for storing data and executable software instructions, and is non-transitory during the time software instructions are stored therein. As used herein, the term “non-transitory” is to be interpreted not as an eternal characteristic of a state, but as a characteristic of a state that will last for a period. The term non-transitory specifically disavows fleeting characteristics such as characteristics of a carrier wave or signal or other forms that exist only transitorily in any place at any time. The memory 320 may store software instructions and/or computer readable code that enable performance of various functions. The memory 320 may be secure and/or encrypted, or unsecure and/or unencrypted.

Similarly, the database 350 may be implemented by any number, type and combination of RAM and ROM, for example, discussed above, The database 350 likewise is a tangible storage medium for storing data and/or executable software instructions, and is non-transitory during the time software instructions are stored therein. The database 350 may be secure and/or encrypted, or unsecure and/or unencrypted.

“Memory” is an example of computer-readable storage media, and should be interpreted as possibly being multiple memories or databases. The memory or database may for instance be multiple memories or databases local to the computer, and/or distributed amongst multiple computer systems or computing devices. A computer readable storage medium is defined to be any medium that constitutes patentable subject matter under 35 U.S.C. § 101 and excludes any medium that does not constitute patentable subject matter under 35 U.S.C. § 101. Examples of such media include non-transitory media such as computer memory devices that store information in a format that is readable by a computer or data processing system. More specific examples of non-transitory media include computer disks and non-volatile memories.

The display 330 may be a monitor such as a computer monitor, a television, a liquid crystal display (LCD), an organic light emitting diode (OLED), a flat panel display, a solid-state display, or a cathode ray tube (CRT) display, or an electronic whiteboard, for example. The display 330 may also provide a graphical user interface (GUI) for displaying and receiving information to and from the user.

The interface 340 may include a user and/or network interface for providing information and data output by the processing unit 310 and/or the memory 320 to the user and/or for receiving information and data input by the user. That is, the interface 340 enables the user to enter data and to control or manipulate aspects of the processes described herein, and also enables the processing unit 310 to indicate the effects of the user's control or manipulation. The interface 340 may connect one or more user interfaces, such as a mouse, a keyboard, a mouse, a trackball, a joystick, a haptic device, a microphone, a video camera, a touchpad, a touchscreen, voice or gesture recognition captured by a microphone or video camera, for example, or any other peripheral or control to permit user feedback from and interaction with the processing unit 310. The interface 340 may further include one or more of ports, disk drives, wireless antennas, or other types of receiver circuitry.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those having ordinary skill in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to an advantage.

Aspects of the present invention may be embodied as an apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer executable code embodied thereon.

While representative embodiments are disclosed herein, one of ordinary skill in the art appreciates that many variations that are in accordance with the present teachings are possible and remain within the scope of the appended claim set. The invention therefore is not to be restricted except within the scope of the appended claims.

1. A method of reducing self-interference from a full-duplex system comprising a transmitter and a receiver co-located with the transmitter, the method comprising:
transmitting a test radio frequency (RF) signal from the transmitter of the full-duplex system, wherein the test RF signal includes a predetermined channel sounding waveform at a carrier frequency;
receiving RF signals at the receiver of the full-duplex system, substantially simultaneously with the transmitting of the test RF signal, wherein the received RF signals include an outside RF signal at the carrier frequency received from an external transmitter and self-interference at the carrier frequency comprising a first portion of the test RF signal received directly from the transmitter;
identifying the predetermined channel sounding waveform in the received RF signals;
quantifying the self-interference using the identified channel sounding waveform, wherein quantifying the self-interference comprises determining a first interference signal of the received RF signals attributable to the first portion of the test RF signal received directly from the transmitter based on the identified channel sounding waveform and first timing of the identified channel sounding waveform associated with a first distance between the receiver and the transmitter; and
adjusting the full-duplex system to correct for the quantified self-interference.

2. The method of claim 1, wherein quantifying the self-interference further comprises determining a second interference signal of the received RF signals attributable to a second portion of the test RF signal reflected to the receiver from at least one near object and second timing of the identified channel sounding waveform associated with a second distance between the receiver and the at least one near object, wherein the second timing is longer than the first timing.

3. The method of claim 2, wherein adjusting the full-duplex system to correct for the quantified self-interference comprises:
determining an impulse response of the quantified self-interference; and
inserting an impulse response filter in the full-duplex system to filter out the quantified self-interference at the receiver.

4. The method of claim 2, wherein adjusting the full-duplex system to correct for the quantified self-interference comprises:
changing at least one of a transmit array of the transmitter or a receive array of the receiver to reduce at least the first interference signal of the quantified self-interference attributable to the first portion of the test RF signal received directly from the transmitter.

5. The method of claim 1, wherein the full-duplex system further comprises a transmit antenna configured to transmit the test RF signal provided by the transmitter, and a receive antenna configured to receive the received RF signals provided to the receiver, and
wherein the first portion of the test RF signal received by the receiver directly from the transmitter leaks from the transmit antenna to the receive antenna.

6. The method of claim 1, wherein the full-duplex system further comprises an antenna configured to transmit the test RF signal provided by the transmitter and to receive the received RF signals provided to the receiver, and a circulator configured to selectively route the test RF signal from the transmitter to the antenna and to route the received RF signals from the antenna to the receiver, and
wherein the first portion of the test RF signal received by the receiver directly from the transmitter leaks through the circulator.

7. A system for reducing self-interference, the system comprising:
at least one external transmitter configured to transmit an outside radio frequency (RF) signal at a carrier frequency; and
a processing unit configured to communicate with a transmitter and a receiver, co-located with the transmitter, in a full-duplex system,
wherein the transmitter is configured to transmit a test RF signal including a predetermined channel sounding waveform at the carrier frequency,
wherein the receiver is configured to receive RF signals substantially simultaneously with the transmitter transmitting the test RF signal, the received RF signals including the outside RF signal received from the at least one external transmitter and self-interference, comprising a first portion of the test RF signal, received directly from the transmitter, and
wherein the processing unit configured to:
identify the predetermined channel sounding waveform in the received RF signals; and
quantify the self-interference using the identified channel sounding waveform, wherein quantifying the self-interference includes determining a first interference signal of the received RF signals attributable to the first portion of the test RF signal received directly from the transmitter based on the identified channel sounding waveform and first timing of the identified channel sounding waveform associated with a first distance between the receiver and the transmitter; and
adjust the full-duplex system to correct for the quantified self-interference.

8. The system of claim 7, further comprising:
at least one near object positioned a predetermined second distance from the receiver,
wherein quantifying the self-interference further includes determining a second interference signal of the received RF signals attributable to a second portion of the test RF signal reflected to the receiver from the at least one near object and second timing of the identified channel sounding waveform associated with the second distance between the receiver and the at least one near object, wherein the second timing is longer than the first timing.

9. The system of claim 7, wherein the processing unit is configured to adjust the full-duplex system to correct for the quantified self-interference by:
determining an impulse response of the quantified self-interference; and
inserting an impulse response filter in the full-duplex system to filter out the quantified self-interference at the receiver.

10. The system of claim 7, wherein the processing unit is configured to adjust the full-duplex system to correct for the quantified self-interference by:
changing at least one of a transmit array of the transmitter or a receive array of the receiver to reduce at least the first interference signal of the quantified self-interference attributable to the first portion of the test RF signal received directly from the transmitter.

11. The system of claim 7, wherein the full-duplex system further comprises a transmit antenna configured to transmit the test RF signal provided by the transmitter, and a receive antenna configured to receive the received RF signals provided to the receiver, and
wherein the first portion of the test RF signal received by the receiver directly from the transmitter leaks from the transmit antenna to the receive antenna.

12. The system of claim 7, wherein the full-duplex system further comprises an antenna configured to transmit the test RF signal provided by the transmitter and to receive the received RF signals provided to the receiver, and a circulator configured to selectively route the test RF signal from the transmitter to the antenna and to route the received RF signals from the antenna to the receiver, and
wherein the first portion of the test RF signal received by the receiver directly from the transmitter leaks through the circulator.

13. The system of claim 10, wherein changing at least one of the transmit array of the transmitter or the receive array of the receiver comprises adjusting power and/or phase of antenna array elements within the transmit array or the receive array.

14. A non-transitory computer readable medium storing instructions for reducing self-interference from a full-duplex system comprising a transmitter and a receiver co-located with the transmitter, wherein the receiver is configured to receive RF signals substantially simultaneously with the transmitter transmitting a test RF signal including a predetermined channel sounding waveform at a carrier frequency, wherein the received RF signals include an outside RF signal received from an external transmitter and self-interference including a first portion of the test RF signal received directly from the transmitter, wherein when executed by a processor unit, the instructions cause the processing unit to:
identify the predetermined channel sounding waveform;
quantify the self-interference using the identified channel sounding waveform, wherein quantifying the self-interference includes determining a first interference signal of the received RF signals attributable to the first portion of the test RF signal received directly from the transmitter based on the identified channel sounding waveform and first timing of the identified channel sounding waveform associated with a first distance between the receiver and the transmitter; and
adjust the full-duplex system to correct for the quantified self-interference.

15. The non-transitory computer readable medium of claim 14, wherein quantifying the self-interference further includes determining a second interference signal of the received RF signals attributable to a second portion of the test RF signal reflected to the receiver from a near object, positioned a predetermined second distance from the receiver, and second timing of the identified channel sounding waveform associated with the second distance between the receiver and the near object.

16. The non-transitory computer readable medium of claim 15, wherein the second timing is longer than the first timing.

17. The non-transitory computer readable medium of claim 14, wherein when executed by a processor unit, the instructions further cause the processing unit to adjust the full-duplex system to correct for the quantified self-interference by determining an impulse response of the quantified self-interference for an impulse response filter inserted in the full-duplex system to filter out the quantified self-interference at the receiver.

18. The non-transitory computer readable medium of claim 14, wherein when executed by a processor unit, the instructions further cause the processing unit to adjust the full-duplex system to correct for the quantified self-interference by changing at least one of a transmit array of the transmitter or a receive array of the receiver to reduce at least the first interference signal of the quantified self-interference attributable to the first portion of the test RF signal received directly from the transmitter.

19. The non-transitory computer readable medium of claim 14, wherein when the full-duplex system further comprises a transmit antenna configured to transmit the test RF signal provided by the transmitter and a receive antenna configured to receive the received RF signals provided to the receiver, the first portion of the test RF signal received by the receiver directly from the transmitter leaks from the transmit antenna to the receive antenna.

20. The non-transitory computer readable medium of claim 14, wherein when the full-duplex system further comprises an antenna configured to transmit the test RF signal provided by the transmitter and to receive the received RF signals provided to the receiver, and a circulator configured to selectively route the test RF signal from the transmitter to the antenna and to route the received RF signals from the antenna to the receiver, the first portion of the test RF signal received by the receiver directly from the transmitter leaks through the circulator.
